(19) United States
(12) Patent Application Publication
(10) Pub. No.: US 2008/0080953 A1
(43) Pub. Date: Apr. 3, 2008

(54) SCREW FOR PLASTIC ARTICLES

(76) Inventor: Martin S.H. Wu, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/619,725

(22) Filed: Jan. 4, 2007

(30) Foreign Application Priority Data
Sep. 18, 2006 (TW) 095134492

(51) Int. Cl. F16B 35/04

(52) U.S. Cl. 411/412

(57) ABSTRACT

A screw for plastic articles includes a head, a shank having an insertion end and a coupling end adjacent to a bottom face of the head, a first thread, and a second thread. The first thread is formed on the shank and extends from the insertion end through the coupling end of the shank. The first thread includes a plurality of convolutions. The second thread is formed on the coupling end of the shank and intermediate the convolutions of the first thread. The second thread has a major diameter smaller than that of the first thread. The first thread includes a plurality of crests. A root is defined between two adjacent crests of the first thread outside the coupling end and has a profile defined by two straight lines that forms an angle of 120-160 degrees therebetween.

### BACKGROUND OF THE INVENTION

1. Field of the Invention

The present invention relates to a screw and, more particularly, a self-tapping screw for fastening plastic articles.

2. Description of the Related Art

Screws for widely used plastic articles requires easy, reliable fastening without causing damage to the plastic articles. Hence, screws for fastening plastic articles generally include: (1) large thread height for providing sufficient engaging depth for the purposes of preventing disengagement, (2) large pitch for preventing disintegration of the materials of the plastic articles under the pressure of the screw threads, and (3) small thread angle to allow easy, rapid insertion of the screw into the plastic articles without the need of applying a large torque to the screw.

FIG. 1 illustrates a conventional screw 1 for plastic articles. The screw 1 includes a shank 11 on which a continuous, asymmetric thread 13 is formed. The thread 13 has an acute thread angle of about 45 □ to allow easy insertion of the screw 1 and to increase friction in the unfastening direction. However, the materials of the plastic articles are liable to be damaged by the steep flanks of the thread 13.

FIG. 2 illustrates another conventional screw 2 for plastic articles. The screw 2 includes a shank 21 on which a first, continuous thread 23 and a second, continuous thread 24 are formed. The first thread 23 and the second thread 24 cooperate to define parallel twin threads along the length of the shank 21. A major diameter of the second thread 24 is smaller than that of the first thread 23. Hence, the second thread 24 acts as a buffering area for prolonging the life of the screw 2 and lowering the manufacturing costs while lowering the rolling ratio (the ratio between the outer diameter of the blank and the major diameter of the screw made from the blank). Namely, skew heads are less likely to occur during formation. Further, the second thread 24 increases the engaging area between the screw 2 and the plastic articles to be fastened, providing a larger tightening force. However, the entry speed of the screw 2 into the plastic articles is slow, as the screw 2 has a high friction coefficient due to large number of convolutions of the threads 23 and 24.

FIG. 3 illustrates a further conventional screw 3 for plastic articles. The screw 3 includes a shank 31 on which a continuous thread 33 is formed. A root (not labeled) between two adjacent crests (not labeled) includes a recessed section 34 having a profile defined by two straight lines 342 that intersect at a point 341 corresponding to the most narrow diameter of the shank. The thread 33 of the screw 3 has large thread height, large pitch, and small thread angle, allowing rapid entry of the screw 3 into the plastic articles, with the recessed sections 34 increasing the contact area for tightening purposes and reducing the risk of disintegration of the materials of the plastic articles. Further, the screw 3 can be made with a blank of a small diameter to reduce the manufacturing cost. However, during formation of the thread 33, the angles of the crests and the roots must be formed at the same time; namely, the rolling ratio is relatively high. Hence, skew heads occur easily, leading to an increase in the manufacturing cost, as the ratio of disqualified products is high.

U.S. Pat. No. 3,861,269 discloses a self-tapping screw including a shank having a single thread portion and a dual thread section. The threads of the dual thread section have identical or different major diameters. The screw produces easy entry and greater holding power after the screw has been fully inserted into the structure of a workpiece. However, the thread angle and the angle of the recessed portions in the roots of the threads of the screw are not discussed.

### SUMMARY OF THE INVENTION

An objective of the present invention is to provide a screw for plastic articles that can be manufactured at low cost and low ratio of disqualified products while providing high tightening force and low insertion torque for rapid fastening.

A screw for plastic articles in accordance with the present invention comprises a head including a bottom face, a shank including an insertion end and a coupling end adjacent to the bottom face of the head, a first thread, and a second thread. The first thread is formed on the shank and extends from the insertion end through the coupling end of the shank. The first thread includes a plurality of convolutions. The second thread is formed on the coupling end of the shank and intermediate the convolutions of the first thread. The second thread has a major diameter smaller than that of the first thread.

The first thread includes a plurality of crests. A root is defined between two adjacent crests of the first thread outside the coupling end and has a profile defined by two straight lines that form an angle of 120-160 degrees therebetween.

Preferably, the first thread has a thread angle of 25-35 degrees, most preferably 30 degrees.

Preferably, the second thread has a thread angle of 35-65 degrees.

In an example, a root defined between two adjacent crests of the first thread on the coupling end of the shank has a profile defined by two straight lines that form an angle of 120-160 degrees therebetween.

In another example, the root defined between two adjacent crests of the first thread on the coupling end of the shank has a profile defined by a single, straight line.

Other objectives, advantages, and novel features of the invention will become more apparent from the following detailed description when taken in conjunction with the accompanying drawings.

### BRIEF DESCRIPTION OF THE DRAWINGS

FIG. 1 is a side elevation of a conventional screw.

FIG. 2 is a side elevation of another conventional screw.

FIG. 3 is a side elevation of a further conventional screw.

FIG. 4 is a side elevation of an example of a screw for plastic articles in accordance with the present invention.

FIG. 5 is a side elevation of a blank for the screw in accordance with the present invention.

FIG. 6 is an enlarged sectional view of a portion of the screw in FIG. 4.

FIG. 7 is a view similar to FIG. 6, illustrating a modified example of the screw in accordance with the present invention.

FIG. 8 is a sectional view illustrating initial stage of use of the screw in FIG. 4.

FIG. 9 is a view similar to FIG. 8, wherein the screw is in a tightened position.

FIG. 10 is a side elevation of another example of the screw in accordance with the present invention.

FIG. 11 is a side elevation of a further example of the screw in accordance with the present invention.

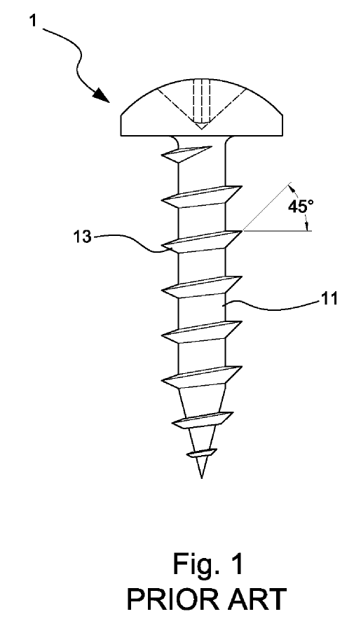

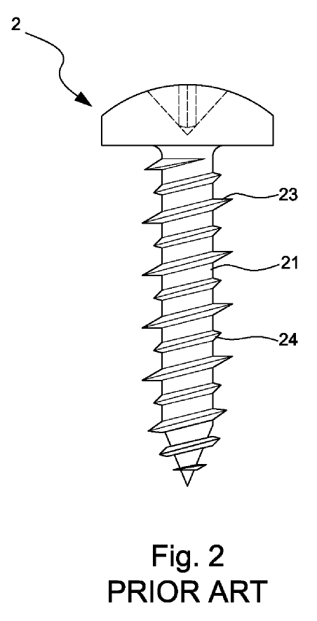

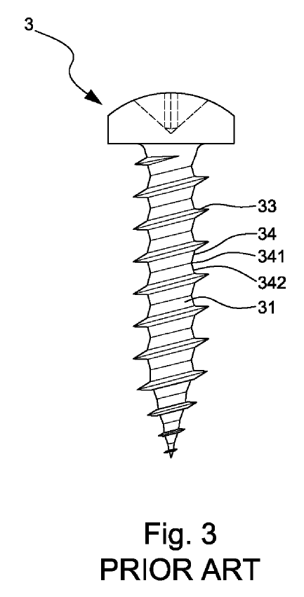

### DETAILED DESCRIPTION OF THE INVENTION

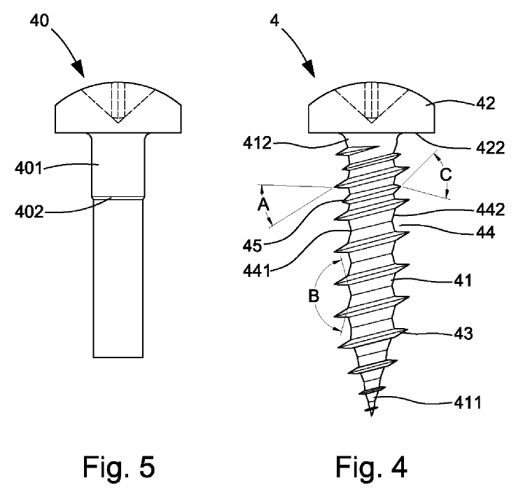

FIG. 4 illustrates an example of a screw 4 in accordance with the present invention. The screw 4 comprises a shank 41 and a head 42 on an end of the shank 41. FIG. 5 shows a blank 40 for forming the screw 4.

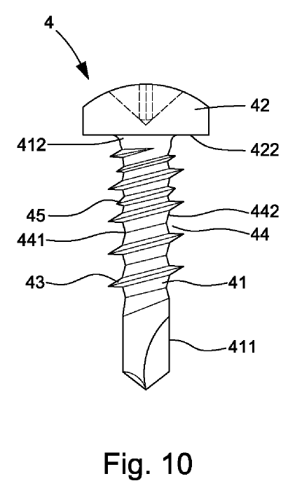

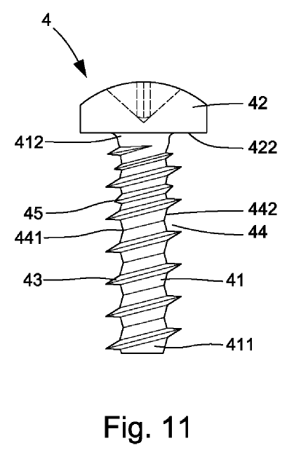

The shank 41 comprises an insertion end 411 for penetrating a plastic article or the like. The shank 41 further comprises a coupling end 41 2 for engaging with the plastic article. In this example, the insertion end 411 has a pointed end. In another example, the insertion end 411 may be of drill bit type, as shown in FIG. 10. In a further example, the insertion end 411 may have a flat end face, as shown in FIG. 11. The coupling end 412 includes an engaging section adjacent to the bottom face 422 of the head 42. An axial length of the engaging section of the coupling end 412 can be adjusted according to the length of the screw 4.

A first thread 43 is formed on an outer circumference of the shank 41 from the coupling end 412 through the insertion end 411. The first thread 43 includes a plurality of convolutions. The types, pitches, or root sizes of the threads 43 may be of any standard sizes. Namely, the threads of the screw 4 in accordance with the present invention are not limited to those shown in the accompanying drawings.

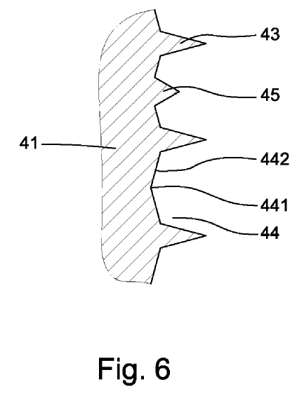

The thread angle A of the first thread 43 is preferably 25-35 degrees, most preferably 30 degrees. In this example, a root 44 between two adjacent crests (not labeled) of the first thread 43 outside the coupling end 412 has a profile defined by two straight lines 442 that intersect at a point 441 that corresponds to the most narrow diameter of the shank 41. Preferably, the root angle B between the straight lines 342 is 120-160 degrees (see FIG. 6).

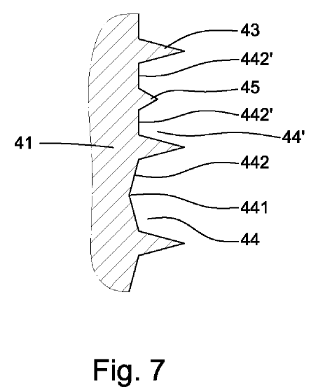

The coupling end 412 of the shank 41 further comprises a second thread 45 on the outer periphery thereof. Preferably, the second thread 45 is intermediate the convolutions of the first thread 43 on the coupling end 412 of the shank 41. The second thread 45 has a major diameter smaller than that of the first thread 43, forming crests of various thread heights on the coupling end 412 of the shank 41. The thread angle C of the second thread 45 is preferably 35-65 degrees, most preferably 55 degrees. The root angle B of the first thread 43 on the coupling end 412 may be 120-160 degrees. Alternatively, the root angle B of the first thread 43 on the coupling end 41 2 may be 180 degrees. Namely, the root 44′ between two adjacent crests (not labeled) of the first thread 43 on the coupling end 412 has a profile defined by a single, straight line 442′, as shown in FIG. 7.

FIG. 5 shows a blank 40 for producing the screw 4, wherein the threads 43 have not formed yet. The blank 40 comprises a head 42 and a shank portion (not labeled). The shank portion has an enlarged section 401 below the head 42 for forming the coupling end 412. An outer diameter of the enlarged section 401 is greater than that of the shank portion by about 5-25%. This allows easy formation of the first and second threads 43 and 45 on the coupling end 412 by rolling. Preferably, the enlarged portion 401 includes a tapered section 402 that tapers toward a distal end of the shank portion. The tapered section 402 may be is a truncated cone or includes a circumferential concave surface. This allows formation of the first thread 43 from the insertion end 411 to a position adjacent to the bottom face 422 of the head 42. The enlarged portion 401 of the blank 40 allows formation of at least one convolution of the second thread 45. In this example, a second thread 45 of two convolutions is formed on the enlarged portion 401 of the blank 40.

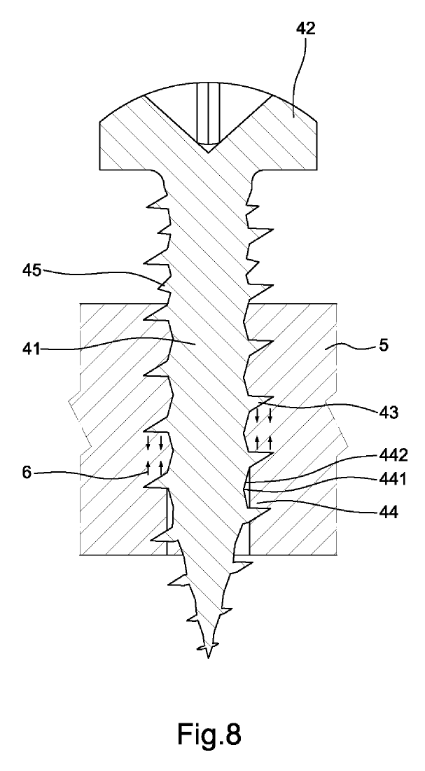

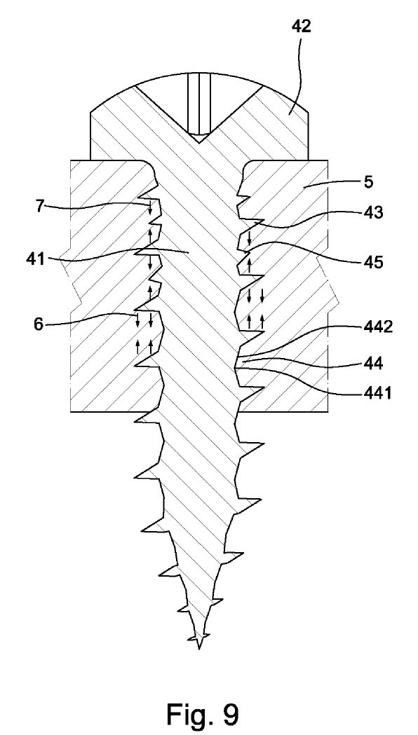

Referring to FIG. 8, when in use, the screw 4 penetrates an object to be fastened (such as a plastic board 5) with the insertion end 411. When the first thread 43 on the shank 41 enters the plastic board 5, the materials of the plastic board 5 between two adjacent crests of the first thread 43 on the shank 41 outside the coupling end 41 2 are moved in directions indicated by the arrows 6, leading to a small engaging force with the first thread 43. Namely, the torque required for driving the screw 4 into the plastic board 5 is small at the beginning stage.

When the screw 4 is driven to a position in which the coupling end 412 of the shank 41 has entered the plastic board 5, the materials of the plastic board 5 between two adjacent crests of the first thread 43 on the coupling end 412 are moved toward the second thread 45, as indicated by the arrows 7. This provides a large engaging force between the materials of the plastic board 5 and the coupling end 412 of the shank 41. Further, the first thread 43 formed on the enlarged section 401 has a larger diameter and, thus, has a larger biting area for the plastic board 5, providing a larger engaging force.

As apparent from the foregoing, the cost for manufacturing the screw 4 in accordance with the present invention is cut, as only the enlarged portion 401 of the blank 4 for forming the coupling end 412 of the screw 4 has a larger diameter. Further, the first thread 43 and the second thread 45 on the coupling end 412 have different major diameters such that the rolling ratio is low, leading to low risk of skew head during formation of the first and second threads 43 and 45. Further, due to the width pitch and large major diameter of the first thread 43, the torque for driving the screw 4 into the article to be fastened is small in the beginning. Damage to the article to be fastened is less likely to occur due to the root angle B of 120-160 degrees of the first thread 43. Further, when the article is in a tightened state (namely, the coupling end 412 of the shank 41 of the screw 4 has entered the article), the engaging force is large enough to prevent disengagement of the screw 4 from the article, and large torque for further driving the screw 4 into the article is not required.

Although specific embodiments have been illustrated and described, numerous modifications and variations are still possible without departing from the essence of the invention. The scope of the invention is limited by the accompanying claims.

What is claimed is:

1. A screw for plastic articles comprising:
a head including a bottom face;
a shank including an insertion end and a coupling end adjacent to the bottom face of the head;
a first thread formed on the shank and extending from the insertion end through the coupling end of the shank, the first thread including a plurality of convolutions; and
a second thread formed on the coupling end of the shank, the second thread being intermediate the convolutions of the first thread, the second thread having a major diameter smaller than that of the first thread;
wherein the first thread includes a plurality of crests, a root being defined between two adjacent said crests of the first thread outside the coupling end and having a profile defined by two straight lines that form an angle of 120-160 degrees therebetween.

2. The screw as claimed in claim 1 wherein the first thread has a thread angle of 25-35 degrees.

3. The screw as claimed in claim 2 wherein the thread angle of the first thread is 30 degrees.

4. The screw as claimed in claim 2 wherein the second thread has a thread angle of 35-65 degrees.

5. The screw as claimed in claim 1 wherein a root defined between two adjacent said crests of the first thread on the coupling end of the shank has a profile defined by two straight lines that form an angle of 120-160 degrees therebetween.

6. The screw as claimed in claim 1 wherein a root defined between two adjacent said crests of the first thread on the coupling end of the shank has a profile defined by a single, straight line.

7. The screw as claimed in claim 2 wherein a root defined between two adjacent said crests of the first thread on the coupling end of the shank has a profile defined by two straight lines that form an angle of 120-160 degrees therebetween.

8. The screw as claimed in claim 2 wherein a root defined between two adjacent said crests of the first thread on the coupling end of the shank has a profile defined by a single, straight line.

9. The screw as claimed in claim 3 wherein a root defined between two adjacent said crests of the first thread on the coupling end of the shank has a profile defined by two straight lines that form an angle of 120-160 degrees therebetween.

10. The screw as claimed in claim 3 wherein a root defined between two adjacent said crests of the first thread on the coupling end of the shank has a profile defined by a single, straight line.

11. The screw as claimed in claim 4 wherein a root defined between two adjacent said crests of the first thread on the coupling end of the shank has a profile defined by two straight lines that form an angle of 120-160 degrees therebetween.

12. The screw as claimed in claim 4 wherein a root defined between two adjacent said crests of the first thread on the coupling end of the shank has a profile defined by a single, straight line.
